(19) United States
(12) Patent Application Publication
(10) Pub. No.: US 2017/0081751 A1
(43) Pub. Date: Mar. 23, 2017

(54) METHOD FOR PRODUCING A PREFORM FROM AN ALPHA+GAMMA TITANIUM ALUMINIDE ALLOY FOR PRODUCING A COMPONENT WITH HIGH LOAD-BEARING CAPACITY FOR PISTON ENGINES AND GAS TURBINES, IN PARTICULAR AIRCRAFT ENGINES

(71) Applicant: LEISTRITZ Turbinentechnik GmbH, Remscheid (DE)

(72) Inventors: Peter JANSCHEK, Dusseldorf (DE); Tobias NAUMANN, Bonn (DE)

(21) Appl. No.: 15/255,557

(22) Filed: Sep. 2, 2016

(30) Foreign Application Priority Data
Sep. 17, 2015 (DE) 10 2015 115 683.0

(51) Int. Cl. C22F 1/18; C22C 14/00; B21J 5/02; B21K 3/04; F01D 5/28; F01D 5/02

(52) U.S. Cl. CPC C22F 1/183; F01D 5/28; F01D 5/02; B21J 5/022; B21K 3/04; C22C 14/00; F05D 2220/323; F05D 2230/41; F05D 2230/25

(57) ABSTRACT

A method for producing a preform from an α+γ titanium aluminide alloy for producing a component with high load-bearing capacity for piston engines and gas turbines, in particular aircraft engines, by forging a blank, wherein the blank held in a manipulator and moved by the manipulator is subjected to merely partial forming by open-die forging by an open-die forging tool.

### CROSS-REFERENCE TO RELATED APPLICATIONS

The present application claims priority of DE 10 2015 115 683.0, filed Sep. 17, 2015, the priority of this application is hereby claimed and this application is incorporated herein by reference.

### BACKGROUND OF THE INVENTION

The invention relates to a method for producing a preform from an α+γ titanium aluminide alloy for producing a component with high load-bearing capacity for piston engines and gas turbines, in particular aircraft engines, by forging a blank.

TiAl-based alloys form part of the group of the intermetallic materials that have been developed for applications in the range of use temperatures for the superalloys. Because of its low density of about 4 g/cm³, this material offers considerable potential for saving of weight and for reduction of the stresses on moving components, for example blades and disks of gas turbines or components of piston engines, at temperatures up to about 700° C. The state of the art is the fine casting of turbine blades, for example, for aircraft engines. For applications with greater stress, for example in high-speed turbines for novel geared turbofan aircraft engines, the properties of the cast structure are no longer adequate. By thermomechanical treatment by means of plastic forming with a defined degree of forming and subsequent heat treatment, it is possible to enhance the static and dynamic properties of TiAl alloys to the required values. However, TiAl alloys cannot be forged in a conventional manner because of their high forming resistance. Therefore, the forming processes have to be conducted at high temperatures in the region of the α+γ or α phase region in a protective atmosphere using tools manufactured from molybdenum at very low forming rates. Achieving the desired final geometry of the forged part generally requires several successive forging steps.

Such a method for producing components with high load-bearing capacity from α+γ-TiAl alloys is known, for example, from DE 101 50 674 B4. The components, especially for aircraft engines or stationary gas turbines, are produced here in a two-stage method. In a first method step, a preform is produced from a blank consisting of α+γ-TiAl alloy. For this purpose, an encapsulated TiAl blank of globular structure is shaped by isothermal forming in the α+γ phase region in the temperature range of 1000-1340° C., or in the α phase region within the temperature range of 1340-1360° C., by forging or extrusion. In a second, likewise isothermal secondary forming process with simultaneous dynamic recrystallization in the α+γ or α phase region within a temperature range of 1000-1340° C., the component is shaped to the defined form by forging, and then the component is solution-annealed to establish the microstructure in the α phase region and then cooled down rapidly. This method thus provides for isothermal preliminary forging to produce the preform and isothermal final forging in the second method step. The forming of a preform is necessary in terms of the volume distribution required in the case of the components described therein, which have very different cross sections in the longitudinal direction, for example turbine blades or piston rods.

However, the forming of the preform in the isothermal primary forming process is very complex. The forming is effected with an extremely slow forming rate; what takes place is effectively extrusion. This means that it is necessary to use a very large press that can exert a pressing force of 400-500 t on the blank. Moreover, the forming takes place with use of molybdenum tools, which means that the forming has to be undertaken in inert atmosphere, i.e. under protective gas, or under reduced pressure. Finally, it is necessary to use relatively large blanks, called billets, in order to have a sufficient volume, but the effect of this is that burrs or offcuts arise at the sides of the preform, which subsequently have to be removed and discarded.

### SUMMARY OF THE INVENTION

The problem addressed by the invention is thus that of specifying a method for producing a preform improved over the latter.

To solve this problem, in a method for producing a preform of the type specified at the outset, it is envisaged in accordance with the invention that the blank held in a manipulator and moved by means of the manipulator is subjected to merely partial forming by open-die forging by means of an open-die forging tool.

The invention envisages production of the preform by open-die forging of a blank. In the open-die forging, using generic tools, the desired form is produced incrementally by repeated action on the workpiece. This forming takes place to a partial degree, meaning that the blank is only being processed locally by means of the open-die forging tool. During this multiple forging operation, a portion of the blank material which has the greatest area to be found in the later finished component in terms of cross section is reduced partially to the cross-sectional area to be found in the finished component at the corresponding point. The forming takes place in that a driven tool, called a die, exerts a multitude of strokes with a defined length at right angles to the longitudinal axis of the starting material, with movement of the blank by means of the program-controlled manipulator between two strokes along a defined path in longitudinal direction of the workpiece. The workpiece is moved by means of the manipulator at least once in a direction through the open-die forging tool and worked with a corresponding number of strokes in the process. If required, backward motion or a multiple repetition of these cycles with a corresponding number of strokes, optionally also with different stroke size, is also possible.

Open-die forging has a number of advantages by comparison with the manner of preform production cited at the outset and implemented to date. Firstly, a much smaller open-die forging apparatus can be used compared to the forge presses to be utilized for the isothermal forming. This is because, in open-die forging, much less force is required per forging operation, i.e. per stroke, because of the smaller volume to be formed. Therefore, an open-die forging apparatus having a forging force of, for example, 10 t is entirely sufficient to undertake the forming. Compared to apparatuses that enable isothermal extrusion and have been used to date, which have to exert a pressing force of several hundreds of tons, for example of 400-500 t, an open-die forging apparatus having a forging force of about 10 t is consequently of a much smaller and simpler design.

The forging operation can also particularly advantageously be effected under air; it need not be undertaken under protective gas. This is because it is possible in principle to use an open-die forging tool made, for example, from a ceramic material, preferably from a fiber-reinforced ceramic material, as a result of the distinctly lower forging force.

Finally, it is also possible to use smaller blanks or billets, since partial, selective and local forming is possible by means of the open-die forging, without formation of lateral burrs or other offcuts to be removed from the preform.

The open-die forging itself is preferably effected in the β phase region. Appropriately, the blank is kept at a temperature in the range of 1070-1300° C. during the open-die forging.

As described, it is preferable to use an open-die forging tool made from a preferably fiber-reinforced ceramic material, which can be used without difficulty under air. Alternatively, it is of course possible in principle to use a forging tool made from molybdenum as well, in which case, however, forging has to be effected under protective gas atmosphere.

The blank and the open-die forging tool itself are heated during the open-die forging, preferably by means of a radiative heating unit, preference being given to using an infrared radiator. Alternatively, the blank can also be heated by means of electrical current flowing through it. In this way, controlled heating can be effected during the forging operation.

It is also appropriate to the purpose when the blank, before being introduced into the open-die forging tool, is heated by means of a radiative heater, by inductive heating or by means of electrical current flowing through the blank. Accordingly, the blank is thus already preheated outside the forging operation. This can likewise be effected using the manipulator that has already gripped the blank. For example, present immediately alongside the open-die forging apparatus is an appropriate heating unit, into which the manipulator moves the blank, and the blank is heated therein. Once it reaches its forging temperature, the blank is sent by means of the manipulator to the open-die forging apparatus and moved between the open-die forging tool for forging.

With regard to typical geometries of the components to be produced from this TiAl alloy for piston engines and gas turbines, which are usually blade-like, the blank is worked by the open-die forging preferably in such a way that the longitudinal expansion is greater than the lateral expansion. By means of the open-die forging, as described, the blank is subjected to only partial forming. The blank forged between the dies is formed during each stroke. The ratio of the length of the tool or of the die in longitudinal direction of the blank, called the “die width”, to the current width of the blank determines whether the preferential forming takes place more with respect to the length (longitudinal expansion) or more with respect to the width (lateral expansion) of the blank. For formation, for example, of a blade preform, a relatively short blank, for example a cylindrical blank, is used, which is on the one hand slightly broadened by the open-die forging, for example in the middle region, until the minimum width that the blade is supposed to have in its final form is at least approximately attained. More particularly, however, the blank undergoes longitudinal expansion, in order that the open-die-forged formed section corresponds to the length of the blade. During the forging, the material is correspondingly formed, i.e. displaced, such that the corresponding lateral expansions and longitudinal expansions can be achieved without difficulty. The longitudinal expansion achieved by the open-die forging should be between 50%-100%; it should be at least 70%.

In a further development of the invention, the blank is worked by open-die forging only in a middle region, so as to leave a first free end section and a second end section, held in the manipulator, of another geometry or another diameter than the open-die-forged region. These two end sections, from which the shroud band and the foot are forged in the finished component, are formed to the final shape only after the open-die forging, i.e. in the second ready-forging operation. However, it is conceivable also to form the first free end section not accommodated in the manipulator to a lesser degree than the middle region during the open-die forging operation, and so, for example, therefore, to level it off or the like.

It is particularly appropriate when the blank is moved by means of the manipulator through the open-die forging tool in such a way that the die blocks over-forge a section forged in a preceding stroke, for example by half. This means that the blank is moved by half the die width by means of the manipulator after each stroke, such that, in the next stroke, the half of the previously forged region is over-forged for a second time. By means of this so-called “bite offset”, it is possible to adjust the degree of forming over the cross section of the component and to achieve homogeneous distribution thereof.

In this case, the blank, if required, can also be rotated about its longitudinal axis by means of the manipulator, in order to produce a round cross section or to introduce torsion and the like.

It is possible to use open-die forging tools of different geometry. It is conceivable to use an open-die forging tool having die blocks having a flat forging surface. Alternatively, it is also possible to use die blocks having a concave-rounded forging surface. By means of such die blocks, it is possible to impart a curved shape approximating to the blade cross section to the forged region.

Finally, it is possible to use an open-die forging tool having die blocks having a three-dimensionally twisted forging surface. With such die blocks, it is possible to forge a defined twist about the longitudinal axis of the preform. If, for example, the ready-forged blade is to twist by 30° from the foot to the shroud band, the three-dimensionally twisted forging surface may have a torsion by 3°, for example. If 10 successive forging strokes in longitudinal direction are conducted, the 3° forming operations each introduced by means of the forging tool are additive, such that the end effect is that the shroud band is offset by 30° relative to the foot. It is thus possible for a defined twist to arise in the over-forged region of the blank or workpiece, resulting from the material flow at the interface.
The alloy used is preferably a TiAl alloy of the following composition (in atom %):
40%-48% Al,
2%-8% Nb,
0.1%-9% of at least one element that stabilizes the β phase, selected from Mo, V, Ta, Cr, Mn, Ni, Cu, Fe, Si,
0%-0.5% B,
and a residue of Ti and melting-related impurities.

The element(s) that stabilize the β phase and have been introduced ensure that the β phase region is stabilized in the forging temperature window.

Particular preference is given to using, as the elements that stabilize the β phase, Mo, V or Ta or a mixture thereof.

The content of the element that stabilizes the β phase should be 0.1%-2%, especially 0.8%-1.2%. This is especially the case when Mo, V and/or Ta are used, since these have a particularly high stabilizing capacity and, therefore, the content thereof can be kept relatively low.

Preference is given to using an alloy of the following composition:
41%-47% Al,
1.5%-7% Nb,
0.2%-8% of at least one element that stabilizes the β phase, selected from Mo, V, Ta, Cr, Mn, Ni, Cu, Fe, Si,
0%-0.3% B,
and a residue of Ti and melting-related impurities.
More specifically, preference is given to using an alloy of the following composition:
42%-46% Al,
2%-6.5% Nb,
0.4%-5% of at least one element that stabilizes the β phase, selected from Mo, V, Ta, Cr, Mn, Ni, Cu, Fe, Si,
0%-0.2% B,
and a residue of Ti and melting-related impurities.
Particular preference is given to using an alloy of the following composition:
42.8%-44.2% Al,
3.7%-4.3% Nb,
0.8%-1.2% Mo,
0.07%-0.13% B,
and a residue of Ti and melting-related impurities.
As well as the method, the invention relates to a preform produced by the method described.

The invention further relates, as well as to the method for producing the preform, to a method for producing a component with high load-bearing capacity from an α+γ titanium aluminide alloy for piston engines and gas turbines, in particular aircraft engines, which has the characteristic feature that a preform produced by the method of the type described above is formed in a one-stage forming step to a defined shape, with isothermal forming of the preform in the β phase region with a logarithmic forming rate of 0.01-0.5 1/s.

The preform produced beforehand in accordance with the invention is formed in a gradual isothermal forming operation with a very low forming rate. The forming is likewise effected at an appropriate temperature in the β phase region. In the course of forming, the 12 sliding planes that exist in the cubic body-centered β phase are activated and dynamic recrystallization is triggered. By means of constant further supply of forming energy, the latter is maintained over the entire forming pathway. This gives rise to a fine-grain microstructure with relatively low flow stress. Since the preform has already been forged relatively near to net shape by the open-die forging, this second forging operation, in spite of the low forming rate of 10⁻³ s⁻¹ to 10⁻¹ s⁻¹, can be effected sufficiently rapidly.

The forming temperature in the β phase region is preferably 1070-1250° C. In this isothermal forming operation, a tool made from a material of high heat resistance is used, preferably made from an Mo alloy, in which case the tools are protected by an inert atmosphere during the forming operation, i.e. protective gas is employed. Alternatively, oxidation can also be avoided by working under reduced pressure.

In addition, it is appropriate to actively heat the tools used for forming, this heating preferably being effected by inductive means.

The preform is appropriately also already heated prior to the forming, which can be effected in an oven, by inductive means or by resistance heating.

After performance of this second isothermal forging operation, it is appropriate to conduct a heat treatment of the formed component, in order to establish the required use properties and, for this purpose, to convert the β phase which is favorable for the forming by a suitable heat treatment to a fine lamellar α+γ structure. For this purpose, the heat treatment may comprise recrystallization annealing at a temperature of 1230-1270° C. The hold time during the recrystallization annealing is preferably 50-100 min. The recrystallization annealing is effected in the region of the γ−α transition temperature. If, as is further envisaged in accordance with the invention, the recrystallization annealing is followed by cooling of the component down to a temperature of 900-950° C. within 120 s or less, relatively small lamellar spacings are formed in the α+γ phase.

Preferably, there follows a second thermal treatment step in which the component is first cooled down to room temperature and then heated to a stabilization or relaxation temperature of 850-950°. Alternatively, it is also possible to go directly from the temperature of 900-950° C. which is rapidly attained after the recrystallization annealing (as described above) to the stabilization and relaxation temperature of 850-950° C. The preferred hold time at the stabilization and relaxation temperature, irrespective of how it has been attained, is preferably 300-360 min.

After the hold time has elapsed, preference is given to reducing the component temperature at a defined cooling rate to a temperature below 300° C. The cooling rate is preferably 0.5-2 K/min, meaning that the cooling is effected relatively slowly, which serves for stabilization and relaxation of the structure. The cooling rate is preferably 1.5 K/min.

The respective cooling can be effected in a liquid, for example in oil, or in air or an inert gas.

As well as the method of the invention for producing the component, the invention further relates to a component made from an α+γ titanium aluminide alloy, especially for a piston engine, an aircraft engine or a gas turbine, produced in a method of the type described. Such a component may, for example, be a blade or a disk of a gas turbine or the like.

The various features of novelty which characterize the invention are pointed out with particularity in the claims annexed to and forming a part of the disclosure. For a better understanding of the invention, its operating advantages, specific objects attained by its use, reference should be had to the drawings and descriptive matter in which there are illustrated and described preferred embodiments of the invention.

### BRIEF DESCRIPTION OF THE DRAWING

In the drawing:

FIG. 1 a schematic diagram for illustration of the method of the invention for production of a preform and of the method of the invention for production of a finished component, and

FIG. 2 a schematic diagram of the blank before and in the course of open-die forging, of the preform and of the ready-forged component.

### DETAILED DESCRIPTION OF THE INVENTION

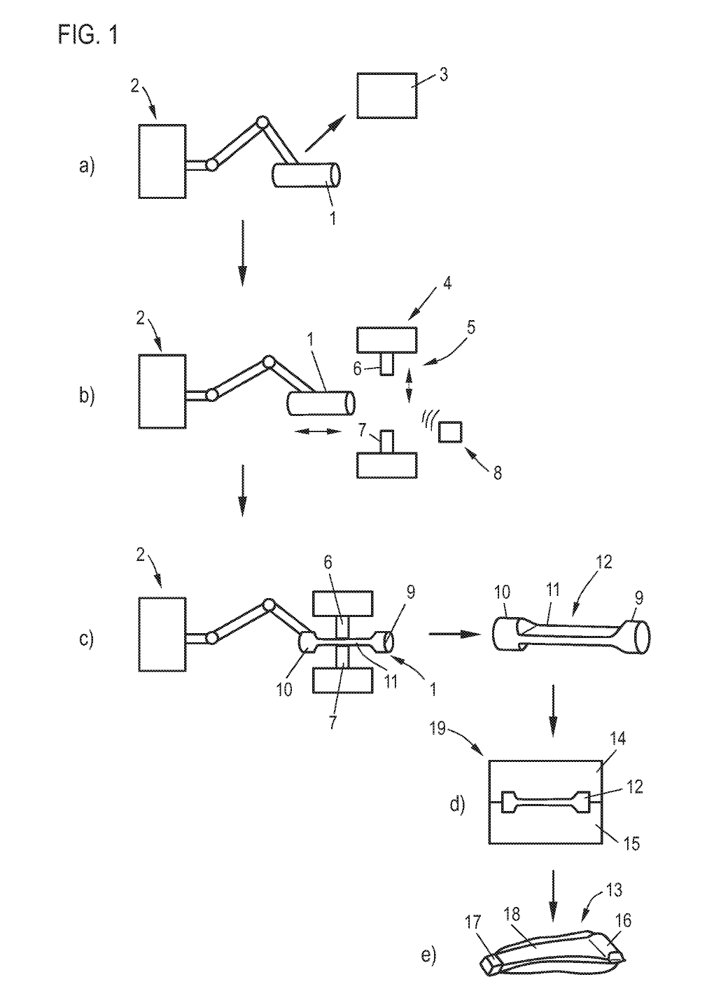

FIG. 1 shows a flow diagram for illustration of the method of the invention for preform production and for finished component production. What is shown is a blank 1 in cylindrical form. This consists of an α+γ titanium aluminide alloy of a composition as specified above. More particularly, the TiAl alloy contains an element that stabilizes the β phase, preferably Mo, V or Ta, since the subsequent forming operations are effected in the β phase region of the TiAl alloy.

The blank 1 is (see step a)) fixed in a program-controlled manipulator 2 or robot. In step a), it is first sent to a first heating unit 3, which may be an infrared radiator, an oven or an electrical heater. In this heating unit 3, the blank 1 is heated up to a temperature in the range of 1070-1330° C., i.e., therefore, a temperature at which a β phase forms in the alloy structure.

On attainment of this temperature (see step b)), the blank 1 is moved by means of the manipulator 2 into an open-die forging apparatus 4 arranged adjacent to the heating unit 3. This open-die forging apparatus 4 has a forging tool 5 comprising a moving die block 6 and a fixed die block 7. The die blocks 6, 7 are preferably made from a ceramic, especially fiber-reinforced, material, such that open-die forging is possible under air. The open-die forging apparatus 4 is designed, for example, for a forging force of 10 t.

The open-die forging apparatus 4 has a dedicated heating unit 8, preferably an infrared radiator, by means of which it is possible to heat the blank 1 present between the die blocks 6, 7 and also the die blocks 6, 7 themselves during the forging operation, such that, in particular, the blank is kept at the appropriate forging temperature.

During the forging operation, the blank 1, as shown by the horizontal double-headed arrow, is moved in intermittent steps through the forging tool 5. At the same time, the die block 6 is raised in individual strokes and lowered onto the blank 1 for forging, and the blank is formed between the die blocks 6, 7. Between every two strokes, the blank 1 is moved by an increment by means of the manipulator 2. The movement is effected, for example, by half the width of the die blocks 6, 7 that have been designed with the same width, such that, with each stroke, the blank 1 is over-forged once again within half the region forged beforehand.

By means of the manipulator 2, the blank 1 is moved at least once in a direction through the open-die forging apparatus 4. If required, it is moved in the opposite direction for performance of a further forging cycle. During this movement, the blank 1 can also, if required, be rotated about its longitudinal axis in order to forge a twist or curves, etc.

The die blocks 6, 7 used may have a flat forging surface or a three-dimensionally shaped forging surface, for example concave-shaped forging surfaces or three-dimensionally twisted forging surfaces, in order to forge controlled geometries.

Step c) shows, for illustrative purposes, the situation during the forging operation. The blank 1 is accommodated between the two die blocks 6, 7, with the die blocks shown in the closed setting for illustrative purposes. It is clear that the blank 1 is being subjected to only partial forming, meaning that a first free end section 9 and a second end section 10, held in the manipulator 2, i.e. the manipulator jaws, is at rest, with the open-die-forged region 11 extending between them. These end sections 9, 10 serve to form the shroud band and the foot of a blade to be produced later, which is still to be discussed hereinafter.

Following on from step c), in enlarged form for illustrative purposes, the ready-forged blank, i.e. the open-die-forged preform 12, is shown. What are shown are the two end sections 9, 10 and the flat-forged middle region 11, from which, in the subsequent second forming step, the blade region is formed. This region 11 has already been altered in terms of its mechanical properties by the open-die forging; because of the multiple forging, it has a very fine microstructure, and any pores are inevitably closed. This is appropriate for the mechanical properties and also for the forming operation for production of the finished component.

This preform 12 is then processed further in a second isothermal forming step for production of a finished component 13 in the form of a turbine blade. This is shown in step d), where the preform 12—optionally having been heated once again beforehand to the forging temperature in a heating unit (not shown)—is introduced into a shaping second forging apparatus 19 having an upper part 14 and a lower part 15. An isothermal forging operation takes place here, in which the upper and lower parts 14, 15 are heated. The forging temperature here too is between 1070-1250°; the forming is effected in the β phase region.

However, the forming is effected here in an isothermal manner at a very slow forming rate; the logarithmic forming rate is in the range of 0.01-0.5 1/s. What effectively takes place is thus extrusion. The tools or molded parts 14, 15 used here are made from an Mo alloy, which is the reason why the forming is effected in a protective gas atmosphere. The forming tools are actively heated, preferably by inductive means.

The finished component is shown in step e), this being a purely schematic diagram. The component 13 is a turbine blade having a shroud band 16 and a foot 17, as is sufficiently well known. The middle region 18, i.e. the actual blade region, is correspondingly curved or twisted in a manner known per se.

The secondary forming operation shown in step d) is then followed by a heat treatment of the formed component 13, for example a recrystallization annealing at a temperature of 1230-1270°, with a hold time between 50-100 min, after which the component is cooled down relatively quickly to a temperature in the range of 900-950°. This is followed by a stabilization and relaxation annealing operation at a temperature in the range of 850-950°, for which it is possible either to heat the component once again or for the prior cooling to already take place to this temperature range. The hold time here is about 300-360 min, after which the component is finally cooled to a temperature below 300° C. at a cooling rate in the range of 0.5-2 K/m in.

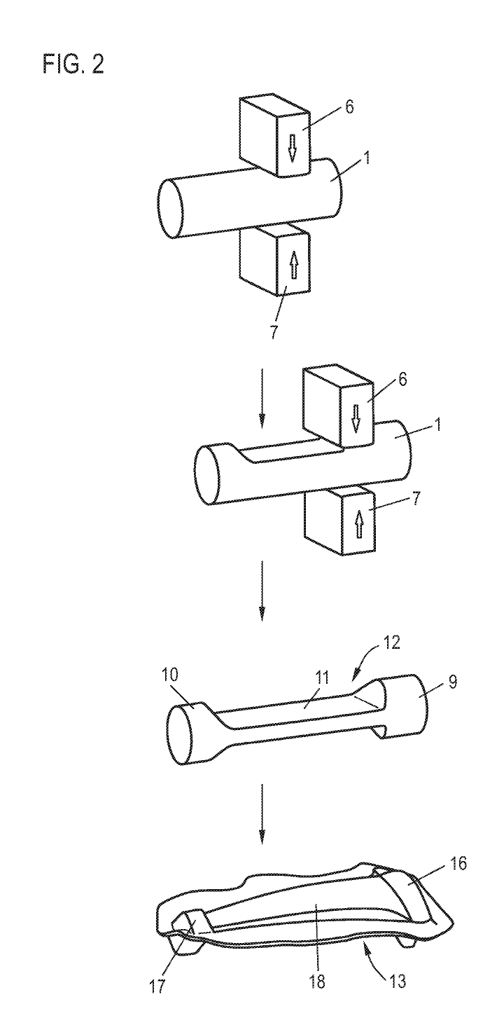

FIG. 2 shows, in an enlarged schematic diagram, the blank, the preform and the ready-forged component. Part a) of the figure shows the cylindrical blank directly after introduction into the open-die forging apparatus; the two die blocks begin the forming work.

Part b) of the figure shows the already partly formed blank. As shown, the ratio of die width (viewed in longitudinal direction of the blank) to the blank width is chosen such that there is primarily longitudinal expansion and only insignificant lateral expansion.

Part c) of the figure shows the ready-open-die-forged preform 12 with the end sections 9, 10 and the formed region 11. The preform is clearly much longer than the blank in the starting state.

This preform is then forged in the second forging apparatus 19 to near net shape in an isothermal manner by extrusion. What is shown is the turbine blade is forged from the region 11 with the blade and the shroud band 16 and the foot 17, both of which have been forged from the end sections 9, 10. Only at the edges are there burrs that still have to be removed.

While specific embodiments of the invention have been shown and described in detail to illustrate the inventive principles, it will be understood that the invention may be embodied otherwise without departing from such principles.

We claim:

1. A method for producing a preform from an α+γ titanium aluminide alloy for producing a component with high load-bearing capacity for piston engines and gas turbines, in particular aircraft engines, by forging a blank, wherein the blank held in a manipulator and moved by means of the manipulator is subjected to merely partial forming by open-die forging by means of an open-die forging tool.

2. The method according to claim 1, wherein the open-die forging is effected in the β phase region.

3. The method according to claim 1, wherein the blank has a temperature in the range of 1070-1300° C. during the open-die forging.

4. The method according to claim 1, wherein an open-die forging tool made from a ceramic material is used.

5. The method according to claim 4, wherein an open-die forging tool made from a fiber-reinforced ceramic material is used.

6. The method according to claim 1, wherein open-die forging tools made from molybdenum are used and the open-die forging is effected under a protective gas atmosphere or under reduced pressure.

7. The method according to claim 1, wherein the blank and the open-die forging tool are heated during the open-die forging by means of a radiative heating unit, or in that the blank is heated by means of electrical current flowing through the blank.

8. The method according to claim 1, wherein the blank, before being introduced into the open-die forging tool, is heated by means of a heating unit, especially a radiative heater, or by means of electrical current flowing through the blank or by inductive means.

9. The method according to claim 1, wherein the blank is worked by the open-die forging in such a way that the longitudinal expansion is greater than the lateral expansion.

10. The method according to claim 1, wherein the longitudinal expansion achieved by the open-die forging is between 50%-100%.

11. The method according to claim 1, wherein the blank is worked by open-die forging only in a middle region, so as to leave a first free end section and a second end section, held in the manipulator, of another geometry or another diameter than the open-die-forged region.

12. The method according to claim 11, wherein, during the open-die forging operation, the first free end section is also formed by the open-die forging, but to a lesser degree than the middle region.

13. The method according to claim 1, wherein the blank is moved by means of the manipulator through the open-die forging tool in such a way that the die blocks over-forge a section forged in a preceding stroke, preferably by half.

14. The method according to claim 1, wherein the blank is rotated about its longitudinal axis by means of the manipulator.

15. The method according to claim 1, wherein an open-die forging tool having die blocks having a flat forging surface is used.

16. The method according to claim 1, wherein an open-die forging tool having die blocks having a concave-rounded forging surface is used.

17. The method according to claim 1, wherein an open-die forging tool having die blocks having a three-dimensionally twisted forging surface is used.

18. The method according to claim 1, wherein the alloy used is a TiAl alloy of the following composition (in atom %):
40%-48% Al,
2%-8% Nb,
0.1%-9% of at least one element that stabilizes the β phase, selected from Mo, V, Ta, Cr, Mn, Ni, Cu, Fe, Si,
0%-0.5% B,
and a residue of Ti and melting-related impurities.

19. The method according to claim 18, wherein the element present in the alloy that stabilizes the β phase is Mo, V or Ta only or a mixture thereof.

20. The method according to claim 18, wherein the content of the element that stabilizes the β phase is 0.1%-2%.

21. The method according to claim 20, wherein the content of the element that stabilizes the β phase is 0.8%-1.2%.

22. The method according to claim 18, wherein a TiAl alloy of the following composition is used:
41%-47% Al,
1.5%-7% Nb,
0.2%-8% of at least one element that stabilizes the β phase, selected from Mo, V, Ta, Cr, Mn, Ni, Cu, Fe, Si,
0%-0.3% B,
and a residue of Ti and melting-related impurities.

23. The method according to claim 18, wherein a TiAl alloy of the following composition is used:
42%-46% Al,
2%-6.5% Nb,
0.4%-5% of at least one element that stabilizes the β phase, selected from Mo, V, Ta, Cr, Mn, Ni, Cu, Fe, Si,
0%-0.2% B,
and a residue of Ti and melting-related impurities.

24. The method according to claim 18, wherein an alloy of the following composition is used:
42.8%-44.2% Al,
3.7%-4.3% Nb,
0.8%-1.2% Mo,
0.07%-0.13% B,
and a residue of Ti and melting-related impurities.

25. A preform produced by a method according to claim 1.

26. A method for producing a component with high load-bearing capacity from an α+γ titanium aluminide alloy for piston engines and gas turbines, in particular aircraft engines, wherein a preform produced by the method according to claim 1 is formed in a one-stage forming step to a defined shape, with isothermal forming of the preform in the β phase region with a logarithmic forming rate of 0.01-0.5 1/s.

27. The method according to claim 26, wherein the forming temperature in the β phase region is 1070-1250° C.

28. The method according to claim 26, wherein forming is accomplished using tools made from a material of high heat resistance.

29. The method according to claim 28, wherein tools made from an Mo alloy are used.

30. The method according to claim 28, wherein the tools are protected by an inert atmosphere during the forming operation, or in that reduced pressure is employed.

31. The method according to claim 26, wherein the tools used for forming are actively heated.

32. The method according to claim 31, wherein the tools are inductively heated.

33. The method according to claim 26, wherein the preform is heated prior to the forming in an oven, by inductive means or by resistance heating.

34. The method according to claim 26, wherein forming is followed by a heat treatment of the formed component.

35. The method according to claim 34, wherein the heat treatment comprises recrystallization annealing at a temperature of 1230-1270° C.

36. The method according to claim 35, wherein the hold time during the recrystallization annealing is 50-100 min.

37. The method according to claim 36, wherein the recrystallization annealing is followed by cooling of the component down to a temperature of 900-950° C. within 120 s or less.

38. The method according to claim 37, wherein the component (13) is then cooled down to room temperature and then heated to a stabilization and relaxation temperature of 850-950° C., or in that the component, without prior cooling, is kept at a stabilization and relaxation temperature of 850-950° C.

39. The method according to claim 38, wherein the hold time at the stabilization and relaxation temperature is 300-360 min.

40. The method according to claim 38, wherein the component is then cooled down to a temperature below 300° C. at a cooling rate of 0.5-2 K/min.

41. The method according to claim 40, wherein the cooling rate is 1.5 K/min.

42. A component made from an α+γ titanium aluminide alloy, especially for a piston engine, an aircraft engine or a gas turbine, produced by the method according to claim 26.
